(19) United States
(12) Patent Application Publication
(10) Pub. No.: US 2022/0391714 A1
(43) Pub. Date: Dec. 8, 2022

(54) PREDICTING A SET OF FITTED KNOWLEDGE ELEMENTS

(71) Applicant: Zendesk, Inc., San Francisco, CA (US)

(72) Inventors: MARIANA SÁ CORREIA LEITE DE ALMEIDA, LISBOA (PT); LOURENÇO MARIA CASELLA VAZ PATO, CASCAIS (PT); PEDRO LUÍS DE FARIA E COELHO, PORTO (PT); RICARDO SILVA BARATA, ESTORIL (PT); RICARDO MANUEL PAULA MARTINS, CAPARICA (PT)

(73) Assignee: Zendesk, Inc., San Francisco, CA (US)

(21) Appl. No.: 17/742,307

(22) Filed: May 11, 2022

(30) Foreign Application Priority Data
Jun. 4, 2021 (PT) 117281

(51) Int. Cl. G06N 5/02; G06K 9/62; H04L 51/02

(52) U.S. Cl. CPC G06N 5/022; G06K 9/6263; H04L 51/02

(57) ABSTRACT

A computer-implemented method for predicting knowledge elements in answer to requests for information, and an associated system that processes the information request (1) made using an intermediate predictive model (5) and a knowledge element prediction fit model (8) to generate a set of fitted knowledge elements to prepare an answer, associated with their respective probabilities of use (12), as a suggestion for the preparation of an answer to an information request (15). The suggested knowledge elements are corrected and/or updated to prepare answers based on historical data, such as: data predicted by the intermediate predictive model (5), answers sent to requesters (15), contents of one or more knowledge elements used in the answers (17) and/or feedback data on the relevance of the answers (21) sent.

### RELATED APPLICATION(S)

This application claims priority to Portuguese patent application number 117281, which was filed Jun. 4, 2021 (Attorney Docket No. ZEN21-103PT) and is incorporated herein by reference.

### BACKGROUND

This disclosure relates to the field of computer systems. More particularly, a system and methods are provided for automating clarification of information requests.

Methods used to respond to requests for information (e.g., from users of a given product or service) usually consist of highly repetitive tasks carried out in customer service centers, seeing that many queries have already been answered previously in reply to similar queries from other requesters. In this context, there are difficulties in prior art methods for standardized and coherent answers to a given subject. Additionally, there is a need for more efficient methods regarding the proper assignment of an information request to the correct sector.

To facilitate the process of replying to information requests, it is common for the agents responsible for preparing an answer to make use of a knowledge base of frequently asked questions, namely the FAQ. A knowledge base includes different knowledge elements that consist of various types of content, such as: articles with structured company information, predefined standard answer templates (also referred to as macros or templates), documents, manuals, images and audio-visual content.

However, a knowledge base of FAQs can contain hundreds or even thousands of informative contents, making the process of finding the most appropriate answer extremely challenging and time consuming.

In order to speed up the process of finding a pertinent answer, one can resort to categorizing information requests into answer categories and then manually associating them with a subset of standardized answers. Thus, as shown in FIG. 1, a customer sends an information request (1), through a computing device (2) and a communication channel (3) to a system that contains a predictive model of answer categories (23), which in turn prepares a set of answer categories that are related to the information request and associated with scores related to their respective relevance probabilities (6), of which an example is shown in Table 1. Next, an automated task manually defined by a human (24) processes the information in Table 1 to identify a set of knowledge elements for the preparation of an answer associated with their respective probabilities of use (25) and linked to the respective answer category, of which an example is shown in Table 2. The identification of a matching set of knowledge elements to prepare an answer associated with their respective probabilities of use (25) should be carried out for each answer category predicted by the predictive model of answer categories (23). Then, according to the most likely answer category, a set of knowledge elements is automatically recommended to prepare an answer associated with their respective probabilities of use (25) associated with that answer category.

TABLE 1

| | Probability or |
|---|---|
| Category of the answer | score (scale of |
| Exchange of contact e-mail | 0.73 |
| Problems with billing | 0.20 |
| Delayed product delivery | 0.03 |

TABLE 2

| Category of the answer | Standard answer |
|---|---|
| Exchange of contact e-mail | Standard answer A |
| Problems with billing | Standard answer B |
| Delayed product delivery | Standard answer C |

The answer category predictive model (23) may be automatic, and its operation based on machine learning methods, or on operations with heuristic rules, which typically provide results of lower quality. In the method shown in FIG. 1, the system still dependents on the prior programming of the automatic task manually defined by a human (24), whose configuration is costly and subject to errors.

Prior art also provides for another option which consists of a predictive model of knowledge elements (26) that directly predicts which standard answers or other elements of the knowledge base should be used, as shown in FIG. 2. Therefore, as shown in FIG. 2, a customer sends an information request (1), through a computing device (2) and a communication channel (3) to a knowledge elements predictive model (26), which prepares a set of knowledge elements that are in turn used to prepare an answer associated with their respective probabilities of use (25), of which an example is shown in Table 3. Again, a simpler knowledge elements predictive model (26) can undertake this categorization based on rules that may be designed by humans, as is typically the case in older systems. Alternatively, the referred knowledge element predictive models (26) may also operate by means of machine learning models, which typically provide better results, taking into consideration that the learning occurs by means of the information history of the requests and their respective answers that may include elements from the knowledge base.

In terms of machine learning models and methods, there are several possible options for the answer category predictive model (23) and the knowledge elements predictive model (26), such as supervised classification models, described by Shervin Minaee et al. in “Deep learning based text classification: A comprehensive review”, in patent application US2018089152A1, by Bordbar Mahyar et al., published on 29 Mar. 2018, and in patent application EP3525107A1, by Bachrach Yoram et al. published on 14 Aug. 2019; the search and sorting models based on fixed features, such as the example described in S. Robertson and H. Zaragoza. “The probabilistic relevance framework: bm25 and beyond”. Found. Trends Inf. Retr., 3(4):333389, April 2009; or learned based on message history, as described in J. Lin, R. Nogueira, and A. Yates. Pretrained transformers for text ranking: Bert and beyond, 2020; or according to the multi-step sequence of sorting and training models, described by Y. Q. Y. Ding et al. in “An optimized training approach to dense passage retrieval for open-domain question answering”, 2020 and in patent application US2017286972A1, by Anantharaman Arvind Kunday et al., published on 5 Oct. 2017; or according to reinforced learning models, according to the example described by Iulian V. Serban et al. in “A Deep Reinforcement Learning Chatbot”.

One of the disadvantages of the solutions described above is the relatively high error incidence rate in the prediction the knowledge elements, or even the subject categories that may be relevant to preparing an answer. This disadvantage persists even when using a good answer category predictive model (23), which predicts the intention, or a good knowledge elements predictive model (26), seeing that no model is 100% perfect. Furthermore, errors in the results provided by the previously described solutions will intensify over time.

On the other hand, customer requests for information (1) vary over time, either gradually with the evolution of society or drastically as a consequence of events, such as campaign launches, the introduction of new products on the market or events that affect the world economy as a whole, such as the covid-19 pandemic. In addition, the knowledge elements base is also dynamic, as new information elements appear resulting from answers to information requests, or even due to the effect of company policies on the content of answers to the same information request. This dynamic present in customer information requests (1) and in the knowledge element bases of companies causes machine learning models to perform below their optimal capacity, resulting in the degradation of the quality of answer suggestion over time.

There are some ways of avoiding this model degradation and outdating problem. The most obvious is to retrain and implement the retrained models frequently. However, this strategy is subject to computational and hardware costs in order to train models and the entire infrastructure cost needed to do so frequently. There is also the possibility of real-time learning (online learning), as well as other techniques that can be applied to change the parameters of the models while they are being used. However, these methods are also subject to the costs of retraining and constantly re-implementing models after changing their parameters. Furthermore, real-time learning methods for neural network models, whose results are the best in various domains, suffer from stability problems and the lack of theoretical convergence analysis, as pointed out by Steven C. H. Hoi et al. in “Online Learning: A Comprehensive Survey”.

It is thus desirable to develop a method for generating answers and/or the knowledge elements for those answers that is effective at compensating for the degradation of their quality over time and that does not require changing model weights to do so, thus avoiding the cost of retraining and re-implementing models too frequently.

TABLE 3

| | Probability or score |
|---|---|
| Standard answer | (scale of 0 to 1) |
| Standard answer 2 | 0.68 |
| Standard answer 13 | 0.27 |
| Standard answer 7 | 0.07 |

### SUMMARY

Embodiments disclosed herein relate, in a first instance, to a computer-implemented method for predicting a set of fitted knowledge elements for the preparations of answers to customer information requests that comprises the following steps:
a. submission of an information request (1) by a customer, from the customer's computing device (2), to a predictive system of answer suggestions to information requests (4), via a communication channel (3);
b. receipt of the information request (1) by the predictive system of answer suggestions to information requests (4);
c. analysis of the information request (1) by an intermediate predictive model (5), which is configured to generate a set of answer categories that are related to the information request and associated with scores relating to their respective relevance probability (6);
d. storing of the set of answer categories that are related to the information request and associated with scores related to their respective relevance probability (6), in computational memory (7);
e. submission of the set of answer categories that are related to the information request and associated with scores related to their respective relevance probability (6), to a knowledge element prediction fit model (8);
f. estimation by the knowledge element prediction fit model (8) of the probability of use of a knowledge element in preparing an answer to an information request (1); whereby the use of each knowledge element is predicted by considering the answer categories predicted by the intermediate predictive model (5) and recorded in the set of answer categories that are related to the information request and associated with scores related to their respective relevance probabilities (6); and whereby the knowledge element prediction fit model (8) is configured to generate a set of fitted knowledge elements for preparing an answer associated with their respective probabilities of use (12);
g. submission of the set of fitted knowledge elements for the preparation of an answer associated with their respective probabilities of use (12) to one or more answering agents (14), whereby an answering agent (14) is selected from a group consisting of a human agent and a conversational robot agent;
h. submission of an answer to an information request (15) by one or more answering agents (14) from the computing device of a customer service unit (13) to the computing device of the customer (2), via a communication channel (3);
i. submission of the feedback set relating to an answer to an information request (16) to the computational memory (7), whereby the referred feedback set relating to the answer to an information request (16) consists of at least one element selected from the group consisting of the answer to an information request (15), the content of one or more knowledge elements used in answering an information request (17) and the external feedback of the relevance of the answer to the information request (21), which may be sent by the customer; and
j. storage of the feedback set relating to the answer to an information request (16) in the computational memory (7);
k. whereby the knowledge element prediction fit model (8) is configured to process, in step f), the set of answer categories relating to an information request, and associated with scores relating to their respective relevance probabilities (6); a historical dataset predicted by the intermediate predictive model relating to categories related with the information request and associated with their respective relevance probabilities (9); and at least one additional historical dataset selected from one or more of the group consisting of a historical dataset of answers sent to a customer (10), of a historical dataset of knowledge elements used in the preparation of answers sent to a customer (11) and a historical dataset of external feedback (22), in order to generate the adjusted set of knowledge elements for the preparation of an answer associated with their respective probabilities of use (12).

Embodiments relate, in a second instance, to a predictive system of a set of fitted knowledge elements for the preparation of answers to customer information requests (4), comprising:

an intermediate predictive model (5), which is configured to analyze an information request (1) sent by a customer from the customer's computing device (2) to the predictive system of answer suggestions to information requests (4), via a communication channel (3); whereby the intermediate predictive model (5) is additionally configured to analyze the information request and generate a set of answer categories related to an information request, and associated with scores related to their respective relevance probabilities (6);

a computational memory (7), which is configured to receive the set of answer categories related with the request for information, and associated with scores related to their respective relevance probabilities (6), from the intermediate predictive model (5); whereby the computational memory (7) is also configured to receive a feedback set relating to the answer to an information request (16), in which the referred feedback set relating to the answer to an information request (16) consists of at least one element selected from the group consisting of the answer to an information request (15), the content of one or more knowledge elements used in answering an information request (17) and the external feedback of the relevance of the answer to the information request (21), which may be sent by the customer;

the knowledge element prediction fit model (8), which is configured to estimate the probability of use of a knowledge element in the preparation of an answer to an information request (1) based on the generation of a set of fitted knowledge elements for the preparation of an answer associated with its respective probabilities of use (12); whereby the knowledge element prediction fit model (8) is also configured to process the set of answer categories that are related with an information request and associated with scores relating to their respective relevance probabilities (6); a historical dataset predicted by the intermediate predictive model relating to the categories that are related with the information request and associated with their respective relevance probabilities (9); and at least one additional historical dataset selected from one or more of the group consisting of a historical dataset of answers sent to a customer (10), a historical dataset of knowledge elements used in the preparation of the answers sent to a customer (11) and a historical dataset of external feedback (22), in order to generate the set of fitted knowledge elements for the preparation of an answer associated with their respective probabilities of use (12); and

a computing device of a customer service unit (13), which is configured to send an answer to an information request (15) via one or more answering agents (14), whereby an answering agent (14) is selected from a group consisting of the human agent and the conversational robot agent, to the customer computing device (2), via a communication channel (3); whereby the computing device of a customer service unit (13) is additionally configured for sending the feedback set relating to the answer to an information request (16), to the computational memory (7).

Embodiments relate, in a third instance, to a computing device comprising means that have been adapted to perform the steps in accordance with the first instance.

Embodiments relate, in a fourth instance, to a computer program consisting of instructions that, when the computer program is performed by a computing device as defined in the third instance, cause said computing device to perform the steps of the method defined in the first instance.

Embodiments relate, in a fifth instance, to a means of reading by a computing device by installing a computer program as defined in the fourth instance.

Embodiments disclosed herein solve problems of the prior art by incorporating a knowledge element prediction fit model (8), which predicts the relevant knowledge elements for preparing an appropriate and updated answer to an information request from a customer (1), whereby said knowledge element prediction fit model (8) corrects and/or updates the predictions made by an intermediate predictive model (5). The correction or update performed by said knowledge element prediction fit model (8) is performed essentially based on historical data predicted by the intermediate predictive model (5) and based on respective historical data from the feedback set relating to the answer to an information request (16).

Disclosed embodiments compensate for the quality degradation of the answer category predictive models (23) and knowledge element predictive models (26) by means of a predictive system for suggesting answers to information requests (4), which automatically compensates over time for errors in predicting the pertinent knowledge elements as content suggestions for the preparation of answers.

The predictive system for suggesting the answers to information requests (4) and the associated method according to some embodiments have several advantages over prior art solutions, such as: i) reducing errors in a system for suggesting elements for answers to customer information requests; ii) reducing degradation of the quality of suggestions of pertinent knowledge elements over time; iii) a greater robustness to changes in customer knowledge bases; iv) an automatic, continuous or very frequent adaptation, for example every hour, without the need for further training and implementation of predictive models embedded in the system, based on the most recent answers given by the answer generation agents and their respective data histories related with the feedback set relating to the answer to an information request (16).

As additional advantages, mention can be made of the high flexibility for integration with any type of intermediate predictive model (5), due to the way the intermediate predictive model (5) communicates with the knowledge element prediction fit model (8) via a computational memory (7). In particular, the intermediate predictive model (5) may have any type of class as an output result, namely the intents of the information requests (1) that are different from the knowledge elements that will be predicted by the knowledge element prediction fit model (8) or one or more types of knowledge elements that will be predicted by the knowledge element prediction fit model (8). Operating independently of the knowledge element prediction fit model (8), the intermediate predictive model (5) may operate in various ways, for example in rule-based and/or machine learning-based way. In terms of automated learning, the model parameters may also be learned in several ways, whereby the intermediate predictive model (5) can be a supervised classification model, as described by Shervin Minaee et al. in “Deep learning-based text classification: A comprehensive review”; a search and sorting model based on fixed features, such as the example described in S. Robertson and H. Zaragoza. “The probabilistic relevance framework: bm25 and beyond”. Found. Trends Inf. Retr., 3(4):333389, April 2009; or learned based on the history, as described by J. Lin, R. Nogueira, and A. Yates in “Pretrained transformers for text ranking: Bert and beyond”, 2020; or according to the multi-step sequence of sorting and training models, described by Y. Q. Y. Ding et al. in “An optimized training approach to dense passage retrieval for open-domain question answering”, 2020; or a reinforced learning model, according to the example described by Iulian V. Serban et al. in “A Deep Reinforcement Learning Chatbot”.

In this context, the output of the intermediate predictive model (5) only needs to be a set of answer categories that are related to the information request and associated with scores relating to their respective relevance probability (6).

The set of fitted knowledge elements for preparing an answer associated with their respective probabilities of use (12) that will be predicted by the knowledge element prediction fit model (8) may also vary, and may include elements such as standard answers (templates) and/or text articles and/or audio-visual content.

### DESCRIPTION OF THE FIGURES

To promote an understanding of the principles involved with the modes of the disclosed embodiments, reference will be made to the modes shown in the figures and to the terminology used to describe them. In any event, it should be understood that there is no intention to limit the scope of the embodiments to the content of the figures. Any subsequent changes or modifications of the inventive features shown herein, as well as any additional applications of the principles and modes of the disclosed embodiments, which would normally occur to an expert in the field with access to this description, are considered within the scope.

FIG. 1 shows a first method of a predictive system of knowledge elements for preparing answers to customer requests for information of the prior art.

FIG. 2 shows a second method of a predictive system of knowledge elements for preparing answers to customer information requests of the prior art.

FIG. 3 shows a first method of the predictive system of a set of fitted knowledge elements for preparing answers to customer information requests according to some embodiments.

FIG. 4 shows a second method of the predictive system of a set of fitted knowledge elements for preparing answers to customer information requests according to some embodiments.

FIG. 5 shows a method of operation of a module for extrapolating the knowledge elements included in an answer, according to some embodiments.

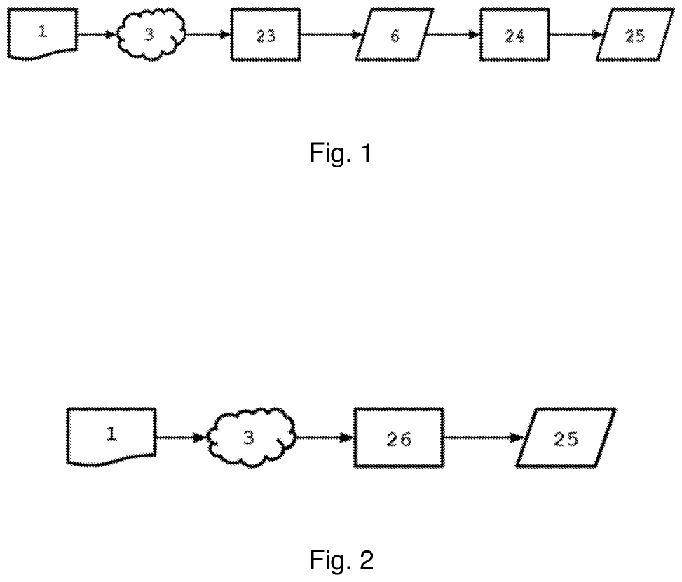

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

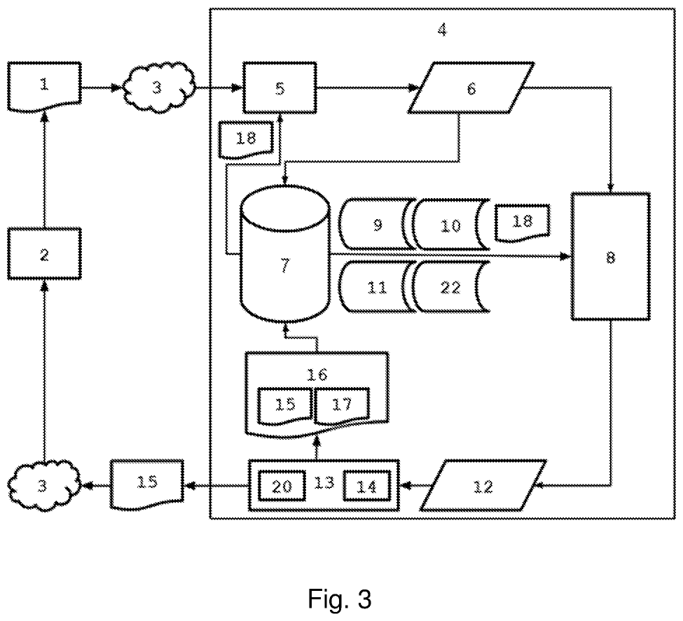

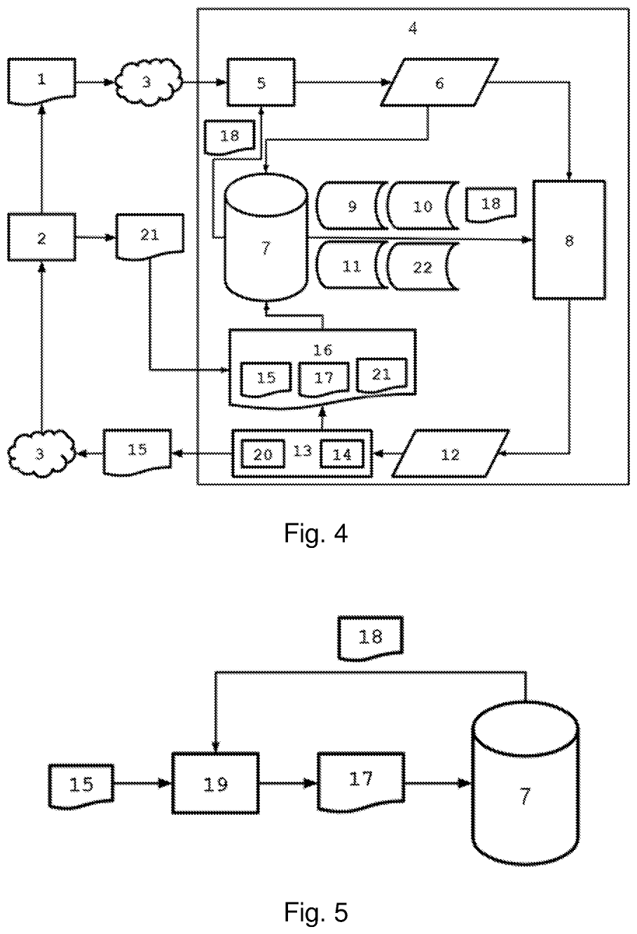

As shown in FIGS. 3 and 4, a method used in the present embodiments takes into consideration the submission of an information request (1) by a customer, from the customer's computing device (2), to a predictive system of answer suggestions to information requests (4), via a communication channel (3).

The client computing device is equipped with some type of computing device configured for sending messages, such as, for example, a computer, a smartphone, a tablet or a smartwatch.

As will be understood by someone skilled in the art, a communication channel (3) may be, for example, a communication network, which includes at least one network selected from a group consisting of a public network, an interconnected set of public and/or private networks, such as the interne, and a private network. Additionally, the communication network may consist of cables or a means of wireless communication.

After the predictive system of answer suggestions to information requests (4) receives the information request (1), the content of the information request (1) is analyzed by an intermediate predictive model (5), which is configured to generate a set of answer categories that are related to the information request and associated with scores relating to their respective relevance probability (6).

By way of example, the intermediate predictive model (5) receives an information request, rₖ, and categorizes it into a set of possible subject categories with associated relevance scores or probabilities. The system operates with various types of subject categories generated by the intermediate predictive model (5), including subjects related to generic operations of company routines, e.g., “Exchange of contact e-mail”, “Problems with billing”, “Delayed product delivery”. Alternatively, the intermediate predictive model (5) can be configured to generate results related directly with elements that are intended to be extracted from the knowledge base, such as standard answers, text articles, pictures and/or audio-visual elements.

A set of answer categories that are related to an information request and associated with scores related to their respective relevance probability (6), predicted by intermediate predictive model (5), can be shown in Table 4.

TABLE 4

| | Probability or |
|---|---|
| Category of the answer | score (scale of 0 |
| Category 11 | 0.71 |
| Category 2 | 0.22 |
| Category 7 | 0.03 |

If the scores of the set of categories of answers that are related to an information request and associated with scores related to their respective relevance probabilities (6), for example identified by s(cᵢ,rₖ), have not already been standardized between 0 and 1, the scores can be standardized to indicate the probability of a given category cᵢ being the correct categorization for an information request rₖ. The standardization for such an indication of probability can be obtained by applying equation (I):

$$P ( {c}_{i} \vert {r}_{k} ) = \frac{{e}^{s ( {c}_{i} , {r}_{k} )}}{{\sum }_{j}^{c} {e}^{s ( {c}_{j} , {r}_{k} )}} \qquad ( I )$$

Where “i” and “j” are indices that index the categories predicted by the intermediate predictive model (5) when it classifies the information requests (1), where “cᵢ” is the i^{th} possible category, “cⱼ” is the j^{th} possible category, and C is the total number of categories that the intermediate predictive model (5) can predict.

In certain execution modes, namely when the intermediate predictive model (5) does not provide scores for some less relevant categories, the method and system of some embodiments are configured in such a way that the probability calculated by the equation (I) is zero.

It should be noted that an information request (1), in particular an information request rₖ, may consist of various types of elements, such as text, image, audio, temporal information, information about the user who sent the information request. Similarly, an answer to an information request (15), namely an answer to(rₖ), may also consist of various knowledge elements, many of which belong to the company's knowledge base, such as text, images, links to articles, audio, audio-visual elements, temporal information, and information relating to the agent preparing the answer.

After generating the set of answer categories that are related to the information request and associated with scores related to their respective relevance probability (6), it is sent to the computational memory (7) and to a knowledge element prediction fit model (8), as shown in FIGS. 3 and 4.

In the preferred modes of the present embodiments, the computational memory (7) stores information related to the set of answer categories that are related to an information request and associated with scores related to their respective relevance probabilities (6); the information related to the feedback set that is related to the answer to an information request (16); a historical dataset predicted by the intermediate predictive model relating to the categories that are related to an information request and associated with their respective relevance probabilities (9); a historical dataset of answers sent to a customer (10); a historical dataset of knowledge elements used in preparing the answers that are sent to a customer (11); and a historical dataset of external feedback (22).

Next, an estimate of the probability of a use of a knowledge element in the preparation of an answer to an information request (1) is performed by the knowledge element prediction fit model (8), which is configured to generate a set of fitted knowledge elements for the preparation of an answer associated with their respective probabilities of use (12), as shown in Table 5.

TABLE 5

| | Probability or score |
|---|---|
| Knowledge element | (scale of 0 to 1) |
| Element 3 | 0.71 |
| Element 12 | 0.22 |
| Element 9 | 0.03 |

In order to estimate the probability of use of a knowledge element in the preparation of an answer to an information request (1) and in order to generate the set of fitted knowledge elements for the preparation of an answer associated with their respective probabilities of use (12), the knowledge element prediction fit model (8) is essentially configured to process the following data:

the set of answer categories that are related to an information request and associated with scores related to their respective relevance probability (6), predicted by intermediate predictive model (5), for the information request (1) being processed; and

a historical dataset predicted by the intermediate predictive model relating to categories that are related to an information request and associated with their respective relevance probabilities (9), for example a historical dataset s(cᵢ,rⱼ).

In preferred modes of the present embodiments, the knowledge element prediction fit model (8) is also configured to process the following information in order to correct and adjust the results predicted by the intermediate predictive model (5):
at least one additional dataset selected from the group consisting of a historical dataset of answers sent to a customer (10), i.e., a historical dataset of a(rₖ) for various rₖ requests;
a historical dataset of knowledge elements used in the preparation of answers that are sent to a client (11), i.e., a historical dataset of e(rₖ) for various rₖ requests; and
a historical dataset of external feedback (22).

Illustratively, for each information request (1), for example, a rₖ request, the knowledge element prediction fit model (8) will estimate the conditional probability, P(eⱼ|cᵢ), of the use of a knowledge base element, e(rₖ), given that the intermediate predictive model (5) classified the rₖ information request as class Estimation is performed by taking into account the historical data related with information request pairs (1) and answer to an information request (15) within a recent time interval, T.

In some embodiments, the temporal information for estimating the probability P_{T}(eⱼ|cᵢ) is made by reference to the frequencies of use of the answer preparation agents during a given recent time period T, for example the last 2 months of operation of a customer service center. As such, the probability P_{T}(eⱼ|cᵢ) can be calculated using equation (II).

$${P}_{T} ( {e}_{j} \vert {c}_{i} ) = \frac{{\#}_{T} ( {e}_{j} , {c}_{i} )}{{\#}_{T} ( {c}_{i} )} \qquad ( II )$$

whereby #T(eⱼ,cᵢ) is the number of information requests (1) answered during the period T that were classified with the category cᵢ and whereby the agent preparing the answer used knowledge element eⱼ from the knowledge base when replying to the information request (1), and #T(cᵢ) is the number of information requests answered during the same time interval T that were classified with the category cᵢ.

In some embodiments, the number of counts in equation (II) may be adjusted so as not to penalize elements that appear very few times. For example, a regularization technique (such as a smoothing technique) can be used in which extra R elements are added that count all combinations of element-category pairs (eⱼ,cᵢ), as indicated in equation (III):

$${P}_{T} ( {e}_{j} \vert {c}_{i} ) = \frac{{\#}_{T} ( {e}_{j} , {c}_{i} ) + R}{{\#}_{T} ( {c}_{i} ) + ER} \qquad ( III )$$

Whereby E in equation (III) is the total number of knowledge elements. Depending on the value of R, the probability PT gets closer to the true frequency count of equation (II) (where R=0) or closer to the continuous uniform distribution (where R=infinite).

Therefore, the knowledge element prediction fit model (8) can suggest knowledge elements that can be used by the answer preparation agents in replying to an information request (1), based on the intermediate predictive model classification (5) and the probability estimate P_{T}(eⱼ|cᵢ).

In some modes of the embodiments, the suggestion of knowledge elements may be made through hard links, wherein the most likely classification of a given ci category, predicted by the intermediate predictive model (5) is assumed to be 100% correct and the probability of using a knowledge base element eⱼ for a given subject category is estimated by means of equation (IV):

P(e)=P_{T}(e|cᵢ) (IV)

In other modes, the suggestion of knowledge elements can be made by soft linking, which takes advantage of the uncertainty of the intermediate predictive model (5) and the probability of using an eⱼ element in the knowledge base for a given subject category is estimated.

Estimating the likelihood P_{T}(eⱼ|cᵢ) requires accessing several elements in the knowledge base and doing a heavy count of the events. This process may become too time-consuming for a typical computational system. Therefore, in other modes, the probabilities P_{T}(eⱼ|cᵢ) may be estimated by considering a temporal sample of historical data relating to all information requests (1) indexed in the computational memory (7).

Alternatively, the conditional probability, P(eⱼ|cᵢ) is updated taking into consideration samples of the historical data collected at regular intervals T_{P}, such as daily or hourly. As such, the small difference that is obtained between an instantaneous or periodically scheduled probability is very small, especially if the aggregation time interval T is much higher when compared to the frequency of updating the probability T_{P}.

Therefore, in the preferred modes of the present embodiments consisting of the use of the predictive system of answer suggestions to information requests (4) in a customer service center of a company or organization, as shown in FIGS. 3 and 4, the knowledge element prediction fit model (8) processes at least one historical dataset predicted by the intermediate predictive model relating to categories that are related to an information request and associated with their respective pertinence probabilities (9), a historical dataset of answers sent to a client (10), a historical dataset of knowledge elements used in preparing answers that will be sent to a client (11), and a historical dataset of external feedback (22), whereby the historical data may be related to a recent time interval of information requests (1) or related to a series of previously defined time intervals of records registered in the computational memory (7). For this purpose, the computational memory (7) is configured to store the respective time data of information requests (1) and of answers to information requests (15). As will be understood by a person skilled in the art, the time interval for acquiring historical data may be differentiated according to the types of input data of the knowledge element prediction fit model (8).

As shown in FIGS. 3 and 4, the intermediate predictive model (5) and the knowledge element prediction fit model (8) may be configured to access the contents of available knowledge elements (18) to generate respective predictions of the set of answer categories that are related to an information request and associated with scores related to their respective probabilities of relevance (6) and of the set of fitted knowledge elements for the preparation answers associated with their respective probabilities of use (12).

In some embodiments, the computational memory (7) is configured to pair the set of answer categories related to an information request and associated with scores related to their respective relevance probabilities (6) with the elements of the respective feedback set that is related to the answer to an information request (16), such as, for example, an answer to an information request (15), the content of one or more knowledge items used in an answer to an information request (17) and the external feedback on the relevance of the answer to an information request (21). Preferably, the referred pairing between elements is performed based on an identification code of the referred information request (1), which is stored in the computational memory (7).

The knowledge element prediction fit model (8) consists of a prediction fitting process based on the history of questions and their respective answers with knowledge elements. This prediction fitting process may be updated instantaneously in situations where the probabilities are fitted every time feedback is provided by the client and/or one or more of the answering agents (14). In other modes, the prediction fitting process is performed in a timed manner, in cases where the frequencies of use of knowledge elements are updated at predefined times

Preferably, the knowledge element prediction fit model (8) estimates the conditional probability of the use of a knowledge element in preparing an answer to an information request (1) in step f) of the method according to some embodiments by calculating a moving average.

The conditional probability P_{T}(eⱼ|cᵢ), of the use of a knowledge base element, e(rₖ), given a subject category cᵢ, can be estimated with variants of equation (IV). In particular, the knowledge element prediction fit model (8) may use some moving average where the points, namely historical pairs of information requests (1) and of answers to an information request (15) are weighted differently, giving greater importance to requests that are more recent.

In some embodiments, the knowledge element prediction fit model (8) may weight the historical pairs of information requests (1) and answers to an information request (15) based on external feedback of the relevance of the answer to an information request (21), namely according to the level of relevance of the answer given to the customer.

In other modes, the knowledge element prediction fit model (8) may weight historical pairs of information requests (1) and answers to an information request (15) based on the association between the answer to an information request (15) and the respective answering agent (14) that sent it. For this purpose, the answer to an information request (15), present in the feedback set relating to the answer to an information request (16), includes information relating to which answering agent (14) sent the answer to the customer. As such, the model (8) may be configured to weight the history of answers to an information request (15) according to which answering agent (14) generated the answer, for example, assigning a greater weight to answers from a human agent or disregarding answers prepared by a robot agent.

In other modes, the knowledge element prediction fit model (8) may weight historical pairs of information requests (1) and answers to an information request (15) based on the characteristics of the information request (1), such as on the size of the request; the type of channel used to send it (such as e-mail, Whatsapp, Facebook or chat); or the classification of the request into a particular set of categories (such as on language or intent).

In general, if a new knowledge element is used by one or more answering agents (14) and receives a satisfactory feedback set regarding the answer to an information request (16) by one or more answering agents (14), the new knowledge element is inserted into the historical loop and will be suggested by the knowledge element prediction fit model (8). As such, the new knowledge element may be forcibly used by one or more answering agents (14). Alternatively, the new knowledge element may be used by a human answering agent (14) after he performs a search of the knowledge element database without resorting to the use of suggestions.

When there is a need to prepare an answer to an information request (15) identifying, for example, personalized customer data in the message, a human answering agent (14) will prepare such an answer. As will be recognized by an expert in the art, the preparation of answers that contain personalized data for a customer may also be automated to some extent, and may be performed by a conversational robot agent. In the same way as an answer to a standardized information request (15), a personalized answer is also sent to the computational memory (7), and is likely to be included in the feedback set relating to the answer to an information request (16).

After estimating the set of fitted knowledge elements for the preparation of an answer associated with their respective probabilities of use (12), the answer is sent to one or more answering agents (14), whereby an answering agent (14) is selected from a group consisting of a human agent and a conversational robot agent. The human agent for the preparation of an answer is a human operator within the context of some embodiments. In illustrative implementations, various answering agents (14) prepare the answer to an information request (15) based on the set of fitted knowledge elements for the preparation of an answer associated with their respective probabilities of use (12).

In this manner, the answering agent (14) receives the set of fitted knowledge elements to prepare an answer associated with their respective probabilities of use (12) and may prepare the answer to an information request (15) based on the information resulting from the processing performed by the knowledge element prediction fit model (8).

Then, one or more answering agents (14) send the answer to an information request (15) from a computing device of a customer service unit (13) to the customer's computing device (2) via a communication channel (3). In some embodiments, sending an answer to an information request (15) by one or more answering agents (14) from a computing device of a customer service unit (13) to the customer computing device (2), is performed via a data and information delivery module (20) and a communication channel (3), as shown in FIGS. 3 and 4. At the same time, a computing device of a customer service unit (13) sends a feedback set relating to the answer to an information request (16) to the computational memory (7), whereby the referred feedback set relating to the answer to an information request (16) consists of at least one element selected from a group consisting of the answer to an information request (15) and the content of one or more knowledge elements used in an answer to an information request (17). As shown in FIG. 4, the feedback set relating to the answer to an information request (16) may also consist of a third information element, namely the external feedback on the relevance of the answer to an information request (21), which may be sent by the customer via a communication channel (3).

In other modes of implementation of the present embodiments, as shown in FIG. 4, at least one answer agent (14) is a conversational robot agent, which is installed in the computing device of a customer service unit (13), whereby the referred conversational robot agent, which prepares the answer based on the set of fitted knowledge elements for the preparation of an answer associated with their respective usage probabilities (12). In these modes, the referred feedback set relating to the answer to an information request (16) consists of at least one element selected from the group consisting of the answer to an information request (15) and the content of one or more knowledge elements used in answering an information request (17), and may be complemented by the external feedback of relevance of the answer to the information request (21). Alternatively, various sets of feedback relating to the answer to an information request (16) may be rectified by a human agent based on an analysis of the relevance of a historical dataset of answers to an information request (15), previously sent by the conversational robot agent, or based on a historical dataset of external feedback of the pertinence of the answer to an information request (21), sent by the customers. The feedback set relating to the answer to an information request (16) may be supplemented by a human agent based on the history of the content of one or more knowledge elements provided in an answer to an information request (17).

In terms of the synchronous and asynchronous operation of the present system, the knowledge element prediction fit model (8) receives the information generated by the intermediate predictive model (5), so both models work in sequence.

The historical dataset, namely the historical dataset predicted by the intermediate predictive model referring to categories related to an information request and associated with their respective pertinence probabilities (9), the historical dataset of answers sent to a customer (10), the historical dataset of knowledge elements used in the preparation of the answers sent to a client (11) and the historical dataset of external feedback (22) may be stored in the computational memory (7) and submitted for processing by the knowledge element prediction fit model (8) asynchronously, in other words, the information is stored in the computational memory (7) as it is made available. In this regard, when the information is sent to the knowledge element prediction fit model (8), the information that has been stored up to the time of use in the computational memory (7) may be used. In the preferred modes of some embodiments, the historical dataset (9, 10, 11, 20) is sent to the knowledge element prediction fit model (8) periodically, for example every hour, and does not need to be instantaneous, allowing for a time lag when being written to the computational memory (7) by the computing device of a customer service unit (13).

As shown in FIGS. 3 and 4, the step of submitting an answer to an information request (15) by one or more answering agents (14) from the computing device of a customer service unit (13) to the computing device of the customer (2), is made via a communication channel (3). In parallel and asynchronously, the feedback set relating to the answer to an information request (16) by one or more answer agents (14) is sent from the computing device of a customer service unit (13) to the computing memory (7), so that this information is available for further processing by the knowledge element prediction fit model (8).

A knowledge element prediction fit model (8) generates a set of fitted knowledge elements for the preparation of an answer associated with their respective usage probabilities (12), according to the needs of an answering agent (14), and the prediction may be programmed to run automatically whenever a request is opened in the e-mail box. The suggestion request can thus be made more than once for the same request for information (1), if the feedback set that is related to the answer to a request for information (16) indicates that the answer to a previous request for information (15) was not relevant.

In some embodiments, the computational memory (7) used by the predictive system for suggesting answers to information requests (4) consists of one or more databases, which will be selected from one or more of a group consisting of a flat database model, a tabular database model, a network database, a hierarchical database model, a relational database model, an object-oriented database model, and an object-relational database, and a graph-oriented database model.

In some of the implementation modes, if one or more knowledge elements used in an answer to an information request (17) that were used by one or more answer agents (14) are not explicitly accessible, they can be extrapolated through the content of the answer itself, aₖ(rᵢ), in order to be subsequently used by the knowledge element prediction fit model (8) in the form of a historical knowledge elements dataset used in the preparation of the answers sent to a customer (11). As such, in these implementation modes, as illustrated in FIG. 5, a knowledge element extrapolation module (19) may also be configured to process only one answer to an information request (15), whereby the knowledge element extrapolation module (19) is configured to process one answer to an information request (15) and the content of available knowledge elements (18) in order to generate, by extrapolation, the content of one or more knowledge elements used in an answer to an information request (17). Therefore, the content of one or more knowledge elements used in an answer to an information request (17) is extrapolated from an answer to an information request (15) and is stored in the computational memory (7), and may be integrated into the historical dataset of knowledge elements used in the preparation of answers sent to a customer (11), eventually used by the knowledge element prediction fit model (8). The knowledge element extrapolation module (19) may be included in a stand-alone manner in the predictive system of answer suggestions to information requests (4) or it may be included in another processing module, for example in the knowledge element prediction fit model (8). When the knowledge element extrapolation module (19) is integrated in the knowledge element prediction fit model (8), there is no need to write to the computational memory (7) as it makes direct use of the content of one or more knowledge elements used in an answer to an information request (17). In illustrative implementations, the knowledge element extrapolation module (19) processes a historical dataset of answers sent to a client (10) in order to convert them into a historical dataset of knowledge elements used in the preparation of answers sent to a customer (11), before writing the information into the computational memory (7).

Therefore, the predictive system of answer suggestions to information requests (4) is particularly configured to implement the computer-implemented method for generating answers to customer information requests, in accordance with the first instance.

In some embodiments, the computing device of a customer service unit (13) consists of a processor, at least one memory and at least one communication interface with a communication channel (3).

In some embodiments, the computational memory (7), the intermediate predictive model (5) and the knowledge element prediction fit model (8) are installed in a unit selected from a group consisting of one or more servers and one or more computing devices. Even more preferably, the computational memory (7) is installed in a server or computing device.

In some embodiments, the computational memory (7) is non-volatile computational memory.

In some embodiments, the computational memory (7) is a collection of computational memories aggregated in the computational apparatus or distributed over one or more servers or one or more computing devices.

In some embodiments, the intermediate predictive model (5) is a model that operates based on rules and/or based on automated learning. In terms of automated learning, the model parameters may be learned based on the history of requests and their respective answers and/or knowledge elements use to prepare those answers, in which the intermediate predictive model (5) can be a supervised classification model, as described by Shervin Minaee et al. in “Deep learning based text classification: A comprehensive review” and in patent application US2017286972A1, by Anantharaman Arvind Kunday et al., published on 5 Oct. 2017; a search and sorting model based on fixed features, such as the example described by S. Robertson and H. Zaragoza. “The probabilistic relevance framework: bm25 and beyond”. Found. Trends Inf. Retr., 3(4):333389, April 2009; or learned based on message history, as described in J. Lin, R. Nogueira, and A. Yates. “Pretrained transformers for text ranking: Bert and beyond”, 2020; or the multi-step sequence of sorting and training models, described by Y. Q. Y. Ding et al. in “An optimized training approach to dense passage retrieval for open-domain question answering”, 2020. It should be noted that, given the variability of models described above, the intermediate model (5) may include, the intermediate model (5) may in certain cases have access during its execution to different pieces of information, such as an information request history (1).

In illustrative implementations, the intermediate predictive model (5) and the knowledge element prediction fit model (8) are installed in a storage unit selected from a group consisting of one or more servers, one or more computing devices and one or more programmable integrated circuits.

As used throughout this patent application, the term “or” is used in the inclusive sense rather than the exclusive sense, unless the exclusive sense is clearly defined in a particular situation. In this context, a sentence of the type “X uses A or B” should be interpreted as including all relevant inclusive combinations, for example “X uses A”, “X uses B” and “X uses A and B”.

As used throughout this patent application, the indefinite articles “a or an” should generally be interpreted as “one or more” unless the meaning the singular meaning is clearly defined in a specific situation.

As presented in this description, terms relating to examples should be interpreted for the purpose of illustrating an example of something and not to indicate a preference.

As used in this description, the term “substantially” means that the real value falls within about 10% of the desired value, variable or related limit, “particularly” within about 5% of the desired value, variable or related limit or “especially” within about 1% of the desired value, variable or related limit.

The subject matter described above is provided to illustrate examples of the disclosed embodiments and should not be construed to limit those embodiments. Also, the terminology used for the purpose of describing specific modes should not be construed to limit the embodiments. As used in the description, the definite and indefinite articles, in their singular form, are intended to be interpreted as also including the plural forms, unless the context of the description explicitly indicates otherwise. It will be understood that the terms “comprise” and “include” when used in this description specify the presence of the related characteristics, elements, components, steps and operations, but do not exclude the possibility that other characteristics, elements, components, steps and operations are also considered.

All modifications, provided that they do not modify the essential characteristics of the claims that follow, should be considered to fall within the scope of the protection of the disclosed embodiments.

### LIST OF REFERENCES

1. A request for information

2. The computing device of a customer

3. A communication channel

4. A predictive system of answer suggestions to information requests

5. An intermediate predictive model

6. A set of answer categories that are related to an information request and associated with scores related to their respective relevance probability

7. Computational memory

8. A knowledge element prediction fit model

9. A historical dataset predicted by the intermediate predictive model relating to categories that are related to an information request and associated with their respective relevance probabilities

10. A historical dataset of answers sent to a customer

11. A historical dataset of knowledge elements used in the preparation of answers sent to a customer

12. A set of fitted knowledge elements used for preparing an answer associated to its respective probabilities of use

13. A computing device of a customer service unit

14. An answering agent

15. An answer to a request for information

16. The feedback set relating to an answer to an information request

17. The content of one or more knowledge elements used in an answer to a request for information

18. The content of the available knowledge elements

19. A knowledge element extrapolation module

20. A data and information delivery module

21. The external feedback relating to the relevance of a request for information

22. A historical dataset of external feedback

23. An answer category predictive model

24. An automatic task defined manually by a human

25. A set of knowledge elements used for preparing an answer associated to its respective probabilities of use

26. A knowledge element predictive model

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method for predicting a set of fitted knowledge elements for preparation of answers to customer information requests, the method comprising:
a) submission of an information request (1) by a customer, from the customer's computing device (2), to a predictive system of answer suggestions to information requests (4), via a communication channel (3);
b) receipt of the information request (1) by the predictive system of answer suggestions to information requests (4);
c) analysis of the information request (1) by an intermediate predictive model (5), which is configured to generate a set of answer categories that are related to the information request and associated with scores relating to their respective relevance probability (6);
d) storing of the set of answer categories that are related to the information request and associated with scores related to their respective relevance probability (6), in computational memory (7);
e) submission of the set of answer categories that are related to the information request and associated with scores related to their respective relevance probability (6), to a knowledge element prediction fit model (8);
f) estimation by the knowledge element prediction fit model (8) of the probability of use of a knowledge element in preparing an answer to an information request (1), wherein:
use of each knowledge element is predicted by considering the answer categories predicted by the intermediate predictive model (5) and recorded in the set of answer categories that are related to the information request and associated with scores related to their respective relevance probabilities (6); and
the knowledge element prediction fit model (8) is configured to generate a set of fitted knowledge elements for preparing an answer associated with their respective probabilities of use (12);
g) submission of the set of fitted knowledge elements for the preparation of an answer associated with their respective probabilities of use (12) to one or more answering agents (14), whereby an answering agent (14) is selected from a group consisting of a human agent and a conversational robot agent;
h) submission of an answer to an information request (15) by one or more answering agents (14) from the computing device of a customer service unit (13) to the computing device of the customer (2), via a communication channel (3);
i) submission of feedback relating to an answer to an information request (16) to the computational memory (7), whereby the referred feedback relating to the answer to an information request (16) consists of at least one element selected from the group consisting of the answer to an information request (15), the content of one or more knowledge elements used in answering an information request (17) and the external feedback of the relevance of the answer to the information request (21), which may be sent by the customer; and
j) storage of the feedback relating to the answer to an information request (16) in the computational memory (7);
whereby the knowledge element prediction fit model (8) is configured to process, in step f):
the set of answer categories that are related with the information request and associated with scores relating to their respective relevance probabilities (6);
a historical dataset predicted by the intermediate predictive model relating to the categories that are related with the information request and associated with their respective relevance probabilities (9); and
at least one additional historical dataset selected from one or more of the group consisting of a historical dataset of answers sent to a customer (10), a historical dataset of knowledge elements used in the preparation of the answers sent to a customer (11) and a historical dataset of external feedback (22), in order to generate the set of fitted knowledge elements for the preparation of an answer associated with their respective probabilities of use (12).

2. The method of claim 1, wherein the computational memory (7) is configured to pair the set of response categories related to an information request and associated with scores related to their respective relevance probabilities (6) with the elements of the respective feedback set relating to the answer to an information request (16).

3. The method of claim 2, wherein the pairing between elements is performed with basis on an identification code of the referred information request (1).

4. The method of claim 1, wherein the knowledge element prediction fit model (8) processes in step f):
at least one historical dataset predicted by the intermediate predictive model relating to categories related to an information request and associated with their respective relevance probabilities (9),
a historical dataset of answers sent to a customer (10),
a historical dataset of knowledge elements used in the preparation of answers to be sent to a customer (11), and
a historical dataset of external feedback (22) related to a recent time interval of information requests (1).

5. The method of claim 1, wherein the knowledge element prediction fit model (8) processes, in step f):
at least one historical dataset predicted by the intermediate predictive model relating to categories related to an information request and associated with their respective relevance probabilities (9),
a historical dataset of answers sent to a customer (10),
a historical dataset of knowledge elements used in the preparation of answers to be sent to a customer (11), and
a historical dataset of external feedback (22) related to a series of previously defined time intervals of information requests (1).

6. The method of claim 1, wherein:
the knowledge element prediction fit model (8) estimates at least one conditional probability, P(eⱼ|cᵢ), of the use of a knowledge base element, e(rₖ);
the intermediate predictive model (5) classifies an information request rₖ as class cᵢ; and
the conditional probability, P(eⱼ|cᵢ), is estimated by considering a temporal sample of historical data relating to a set of information requests (1) indexed in the computational memory (7).

7. The method of claim 1, wherein:
the knowledge element prediction fit model (8) estimates at least one conditional probability, P(eⱼ|cᵢ), of the use of a knowledge base element, e(rₖ);
the intermediate predictive model (5) classifies an information request rₖ as class cᵢ; and
the conditional probability, P(eⱼ|cᵢ), is updated by considering samples of the historical data collected at regular time intervals.

8. The method of claim 7, wherein the knowledge element prediction fit model (8) estimates the conditioned probability of the use of a knowledge element in the preparation of an answer to an information request (1) in step f) by calculating a simple moving average, a weighted moving average or an exponential moving average.

9. The method of claim 1, wherein the feedback set relating to a response to an information request (16) consists of an answer to an information request (15) sent by a conversational robot agent acting as an answering agent (14).

10. The method of claim 1, wherein the human agent rectifies various sets of feedback related to the answer to a request for information (16).

11. The method of claim 1, wherein the intermediate predictive model (5) and/or the knowledge element prediction fit model (8) is configured to access the contents of available knowledge elements (18) to generate the set of answer categories that are related to an information request and associated with scores related to their respective probabilities of relevance (6) and the set of fitted knowledge elements for the preparation answers associated with their respective probabilities of use (12).

12. The method of claim 1, wherein a knowledge element extrapolation module (19) processes at least one answer to a request for information (15), and the content of the available knowledge elements (18), to generate, by extrapolation, the content of one or more knowledge elements used in an answer to a request for information (17).

13. The method of claim 1, wherein:
the knowledge element prediction fit model (8) is configured to weight historical pairs of information requests (1) and answers to an information request (15) differently; and
a greater weight is given to the referred historical pairs in at least one of the selected conditions of the group consisting of historical pairs that are more recent, historical pairs that have received external feedback as being a relevant answer to a favorable request for information (21), and historical pairs relating to answers to an information request (15) sent by a human answering agent (14).

14. A predictive system for the preparation of answers to information requests (4), the system comprising:
an intermediate predictive model (5), which is configured to analyze an information request (1) sent by a customer from the customer's computing device (2) to the predictive system of answer suggestions to information requests (4) via a communication channel (3), wherein the intermediate predictive model (5) is additionally configured to analyze the information request and generate a set of answer categories related to an information request, and associated with scores related to their respective relevance probabilities (6);
a computational memory (7), which is configured to receive the set of answer categories related with the request for information and associated with scores related to their respective relevance probabilities (6), from the intermediate predictive model (5), wherein the computational memory (7) is also configured to receive a feedback set relating to the answer to an information request (16), in which the referred feedback set relating to the answer to an information request (16) consists of at least one element selected from the group consisting of the answer to an information request (15), the content of one or more knowledge elements used in answering an information request (17) and the external feedback of the relevance of the answer to the information request (21), which may be sent by the customer;
a knowledge element prediction fit model (8), which is configured to estimate the probability of use of a knowledge element in the preparation of an answer to an information request (1) based on the generation of a set of fitted knowledge elements for the preparation of an answer associated with its respective probabilities of use (12), wherein the knowledge element prediction fit model (8) is also configured to process:
the set of answer categories that are related with an information request and associated with scores relating to their respective relevance probabilities (6);
a historical dataset predicted by the intermediate predictive model relating to the categories that are related with the information request and associated with their respective relevance probabilities (9); and
at least one additional historical dataset selected from the group consisting of a historical dataset of answers sent to a customer (10), a historical dataset of knowledge elements used in the preparation of the answers sent to a customer (11) and a historical dataset of external feedback (22), in order to generate the set of fitted knowledge elements for the preparation of an answer associated with their respective probabilities of use (12); and
a computing device of a customer service unit (13), which is configured to send an answer to an information request (15) via one or more answer agents (14), whereby an answer agent (14) is selected from a group consisting of the human agent and the conversational robot agent, to the customer computing device (2), via a communication channel (3), wherein the computational device of a customer service unit (13) is additionally configured for sending feedback relating to the answer to an information request (16), to the computational memory (7).

15. The predictive system of claim 14, wherein the computing device of a customer service unit (13) comprises a processor, at least one memory, and at least one communication interface with a communication channel (3).

16. The predictive system of claim 15, wherein the communication channel (3) comprises at least one communication network selected from the group consisting of a public network, an interconnected set of public and/or private networks, and a private network.

17. The predictive system of claim 14, wherein the computational memory (7), the intermediate predictive model (5), and the knowledge element prediction fit model (8) are installed in a unit selected from the group consisting of one or more servers and one or more computing devices.

18. The predictive system of claim 14, wherein the intermediate predictive model (5) and the knowledge element prediction adjustment model (8) are installed in a storage unit selected from the group consisting of one or more servers, one or more computing devices, and one or more programmable integrated circuits.

19. The predictive system of claim 14, wherein the intermediate predictive model (5) and/or the knowledge element prediction fit model (8) are configured to access the contents of available knowledge elements (18) to generate the set of answer categories that are related to an information request and associated with scores related to their respective probabilities of relevance (6) and the set of fitted knowledge elements for the preparation answers associated with their respective probabilities of use (12).

20. The predictive system of claim 14, wherein the computational memory (7) is configured to pair the set of response categories related to an information request and associated with scores related to their respective relevance probabilities (6) with the elements of the respective feedback set relating to the answer to an information request (16).

21. The predictive system of claim 14, further comprising:
a knowledge element extrapolation module (19) configured to process an answer to an information request (15) and the content of available knowledge elements (18), in order to generate, by extrapolation, the content of one or more knowledge elements used in an answer to an information request (17).

22. The predictive system of claim 21, wherein the knowledge element extrapolation module (19) is integrated into the knowledge element prediction fit model (8).

23. A non-transitory computer-readable medium storing instructions that, when executed by a processor, cause the processor to perform a method for predicting a set of fitted knowledge elements for preparation of answers to customer information requests, the method comprising:
a) submission of an information request (1) by a customer, from the customer's computing device (2), to a predictive system of answer suggestions to information requests (4), via a communication channel (3);
b) receipt of the information request (1) by the predictive system of answer suggestions to information requests (4);
c) analysis of the information request (1) by an intermediate predictive model (5), which is configured to generate a set of answer categories that are related to the information request and associated with scores relating to their respective relevance probability (6);
d) storing of the set of answer categories that are related to the information request and associated with scores related to their respective relevance probability (6), in computational memory (7);
e) submission of the set of answer categories that are related to the information request and associated with scores related to their respective relevance probability (6), to a knowledge element prediction fit model (8);
f) estimation by the knowledge element prediction fit model (8) of the probability of use of a knowledge element in preparing an answer to an information request (1), wherein:
use of each knowledge element is predicted by considering the answer categories predicted by the intermediate predictive model (5) and recorded in the set of answer categories that are related to the information request and associated with scores related to their respective relevance probabilities (6); and
the knowledge element prediction fit model (8) is configured to generate a set of fitted knowledge elements for preparing an answer associated with their respective probabilities of use (12);
g) submission of the set of fitted knowledge elements for the preparation of an answer associated with their respective probabilities of use (12) to one or more answering agents (14), whereby an answering agent (14) is selected from a group consisting of a human agent and a conversational robot agent;
h) submission of an answer to an information request (15) by one or more answering agents (14) from the computing device of a customer service unit (13) to the computing device of the customer (2), via a communication channel (3);
i) submission of feedback relating to an answer to an information request (16) to the computational memory (7), whereby the referred feedback relating to the answer to an information request (16) consists of at least one element selected from the group consisting of the answer to an information request (15), the content of one or more knowledge elements used in answering an information request (17) and the external feedback of the relevance of the answer to the information request (21), which may be sent by the customer; and
j) storage of the feedback relating to the answer to an information request (16) in the computational memory (7);
whereby the knowledge element prediction fit model (8) is configured to process, in step f):
the set of answer categories that are related with the information request and associated with scores relating to their respective relevance probabilities (6);
a historical dataset predicted by the intermediate predictive model relating to the categories that are related with the information request and associated with their respective relevance probabilities (9); and
at least one additional historical dataset selected from one or more of the group consisting of a historical dataset of answers sent to a customer (10), a historical dataset of knowledge elements used in the preparation of the answers sent to a customer (11) and a historical dataset of external feedback (22), in order to generate the set of fitted knowledge elements for the preparation of an answer associated with their respective probabilities of use (12).
